(19) United States
(12) Patent Application Publication
(10) Pub. No.: US 2025/0308006 A1
(43) Pub. Date: Oct. 2, 2025

(54) IMAGE PROCESSING METHOD, DEVICE AND APPARATUS

(71) Applicant: Lenovo (Beijing) Limited, Beijing (CN)

(72) Inventor: Shuangxin YANG, Beijing (CN)

(21) Appl. No.: 19/085,743

(22) Filed: Mar. 20, 2025

(30) Foreign Application Priority Data
Mar. 29, 2024 (CN) 202410381763.9

(51) Int. Cl. G06T 5/92; G06T 5/50

(52) U.S. Cl. CPC G06T 5/92; G06T 5/50; G06T 2207/20208; G06T 2207/20221

(57) ABSTRACT

An image processing method including obtaining a plurality of image frames acquired by an image acquisition component, and, based on the plurality of image frames, generating a first target image frame, the plurality of image frames being obtained by the image acquisition component continuously acquiring at different times within a preset time period, the plurality of image frames including a first pixel and a second pixel, each of which having a different exposure duration, the plurality of image frames including image frames with the same maximum exposure duration.

### CROSS-REFERENCES TO RELATED APPLICATION

This application claims priority to Chinese Patent Application No. 202410381763.9 filed on Mar. 29, 2024, the entire content of which is incorporated herein by reference.

### FIELD OF TECHNOLOGY

The present disclosure relates to the field of image processing and, more specifically, to an image processing method, device and apparatus.

### BACKGROUND

At present, when synthesizing a high dynamic range (HDR) image using multiple image frames, the same exposure duration needs to be applied to all pixels on the entire image acquisition component. Since the entire image acquisition component sequentially applies significantly different exposure durations, the image acquisition component needs to converge to effectively output image frames, which greatly limits the efficiency of outputting HDR images.

### SUMMARY

One aspect of this disclosure provides an image processing method. The image processing method includes obtaining a plurality of image frames acquired by an image acquisition component, and, based on the plurality of image frames, generating a first target image frame. The plurality of image frames are obtained by the image acquisition component continuously acquiring at different times within a preset time period. The plurality of image frames include a first pixel and a second pixel, each of which having a different exposure duration. The plurality of image frames include image frames with the same maximum exposure duration.

Another aspect of this disclosure provides an electronic device. The electronic device includes an image acquisition component and a processor. The image acquisition component is configured to acquire a plurality of image frames. The processor is configured to obtain the plurality of image frames acquired by the image acquisition component, and generate a first target image frame based on the plurality of image frames. The plurality of image frames are obtained by the image acquisition component continuously acquiring at different times within a preset time period. The plurality of image frames include a first pixel and a second pixel, each of which having a different exposure duration. The plurality of image frames include image frames with the same maximum exposure duration.

Another aspect of this disclosure provides an image processing device. The image processing device includes an image acquisition module and a generating module. The image acquisition module is configured to obtain a plurality of image frames acquired by an image acquisition component. The generating module is configured to generate a first target image frame based on the plurality of image frames. The plurality of image frames are obtained by the image acquisition component continuously acquiring at different times within a preset time period. The plurality of image frames include a first pixel and a second pixel, each of which having a different exposure duration. The plurality of image frames include image frames with the same maximum exposure duration.

### BRIEF DESCRIPTION OF THE DRAWINGS

The following drawings are merely examples for illustrative purposes according to various disclosed embodiments and are not intended to limit the scope of the present disclosure. In the drawings, same or similar reference numerals/characters refer to the same or corresponding parts.

FIG. 1 is a flowchart of an image processing method according to some embodiments of the present disclosure.

FIG. 2 is a process diagram of a synthesizing a first target image frame from a plurality of image frames according to some embodiments of the present disclosure.

FIG. 3 is a schematic diagram of a camera internal interaction process when generating an HDR image according to some embodiments of the present disclosure.

FIG. 4 is a flowchart of the image processing method according to some embodiments of the present disclosure.

FIG. 5 is a schematic structural diagram of an image process device according to some embodiments of the present disclosure.

FIG. 6 is a schematic structural diagram of an electronic device according to some embodiments of the present disclosure.

FIG. 7 is a schematic structural diagram of an electronic device according to some embodiments of the present disclosure.

### DETAILED DESCRIPTION

The present disclosure provides an image processing method. The method can be executed by a processor of a computer device. The computer device may be a device with a multimedia data recording function, including a server, a laptop, a tablet, a tabletop computer, a smart television, a TV box, or a mobile device (such as a mobile phone, a portable video player, a personal digital assistant, a dedicated messaging device, or a portable gaming device).

In conventional technology, there are two methods to obtain HDR images.

The first method is single-frame acquisition and synthesis. This method requires the use of special acquisition sensors, such as a four-in-one sensor, which divides the pixels into several units. Each unit has pixels with different exposure durations. Multiple pixels with different exposure durations in each unit are finally synthesized into one pixel to obtain an HDR image frame. This method is efficient, but there will be a loss in resolution. Secondly, the single-frame method does not address the shutter convergence delay.

The second method is multi-frame acquisition and synthesis. This method continuously captures multiple image frames with different exposure durations. This method mainly controls the exposure duration by the shutter, uses different shutter speeds to obtain multiple image frames with different exposure durations, and then uses the multiple image frames with different exposure durations to synthesize an HDR image frame. This method does not lose resolution, but the delay in capturing multiple frames and the delay in shutter convergence between frames result in slow image output efficiency.

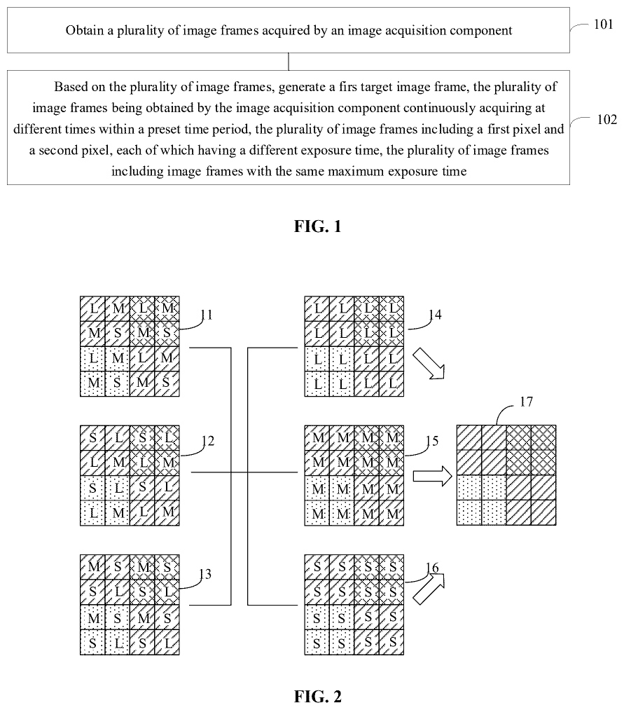

Based on this, embodiments of the present disclosure provide an image processing method. FIG. 1 is a flowchart of an image processing method according to some embodiments of the present disclosure. The method will be described in detail below.

101, obtaining a plurality of image frames acquired by an image acquisition component.

In some embodiments, the image acquisition component may be a device that converts optical image information into electrical signals to generate image frames, which is widely used in cameras and other electronic optical devices.

In some embodiments, the image acquisition component may be an all-in-one image sensor. In some embodiments, the all-in-one image sensor may be a four-in-one image sensor. The four-in-one sensor may include a pixel array and a filter array arranged on the pixel array. Each filter unit in the filter array covers a pixel unit in the pixel array, and each pixel unit has 2*2 pixels.

In some embodiments, when using a camera to take photos or record videos, the camera can use the same shutter speed to collect image frames. It should be understood that since there is no need to frequently change the shutter speed, the image sensor can effectively output image frames without convergence, thereby improving the acquisition efficiency of the image frames, which helps to subsequently improve the output efficiency of the first target image frame.

102, based on the plurality of image frames, generating a first target image frame, the plurality of image frames being obtained by the image acquisition component continuously acquiring at different times within a preset time period, the plurality of image frames including a first pixel and a second pixel, each of which having a different exposure duration, the plurality of image frames including image frames with the same maximum exposure duration.

It should be understood that the first target image frame is not obtained directly from the image acquisition component, but is obtained based on the plurality of image frames through some algorithm or technology processing. The purpose of generating the first target image frame is generally to improve the image quality, enhance certain characteristics of the image, or remove unwanted noise and artifacts. For example, based on the plurality of image frames, an image with a moderate exposure can be generated, while the image frames in the plurality of image frames may be overexposed or underexposed.

In some embodiments, when using a camera for shooting or recording, the camera can use the same shutter speed to capture image frames and perform differentiated exposure control on the pixels in the captured image frames. In this way, the first pixel and the second pixel with different exposure durations in each image frame can be realized. In addition, since the camera uses the same shutter speed to capture image frames, different image frames can have the same maximum exposure duration.

In some embodiments, the first target image frame may be an HDR image frame. The first pixel may have a short exposure duration and the second pixel may have a long exposure duration. In this way, information of overexposure of highlight areas and rich details of shadow areas in the plurality of image frames can be integrated, and the HDR image frame (i.e., the first target image frame) can be synthesized by merging this information. This allows for a wider dynamic range while preserving detail and reducing information loss due to lighting differences.

In some embodiments, differentiated exposure control within an image frame can be achieved by assigning different exposure values (EV) to pixels within the image frame.

Consistent with the present disclosure, by obtaining a plurality of image frames acquired by the image acquisition component, a first target image frame can be generated based on the plurality of image frames. The plurality of image frames can be obtained by the image acquisition component continuously acquiring at different times within a preset time period. The plurality of image frames include a first pixel and a second pixel having different exposure durations in each of the image frames. Each image frame included in the plurality of image frames has the same maximum exposure duration. In this way, compared with the first method described above, the image processing method of the present disclosure does not lose resolution. Compared with the second method described above, since each image frame has the same maximum exposure duration, when the image acquisition component is used to acquire a plurality of image frames, the same exposure duration can be sequentially applied to the entire image acquisition component. That is, the same shutter speed is applied sequentially to the entire image acquisition component, there is no shutter convergence delay, and subsequent pixel differential exposure control can obtain multiple image frames. In this way, the image acquisition component can effectively output image frames without convergence, thereby improving the efficiency of generating the first target image frame using a plurality of image frames, thereby effectively improving the user experience.

In some embodiments, in each of the image frames included in the plurality of image frames, the exposure durations of pixels located at the same position may be different from each other.

In image processing, each image frame can be viewed as a two-dimensional array, where each pixel represents a point in the image. These pixels can be identified by their location in the image frame (generally by row and column coordinates). Therefore, pixels located at the same position refer to pixels having the same coordinates in each image frame.

In some embodiments, since pixels at the same position in each of the plurality of image frames may have different exposure durations, a high-quality HDR image frame may be generated using the plurality of image frames.

In the embodiments of the present disclosure, since the exposure durations of pixels at the same position in each of the plurality of image frames may be different from each other, the plurality of image frames can be used to generate a high-quality first target image frame.

In some embodiments, the process of generating the first target image frame based on the plurality of image frames at 102 may include the following processes.

111, splicing the pixels with the same exposure duration in each of the plurality of image frames to obtain a plurality of combined image frames.

For any pixel, its position in the image frame may be the same as that in the combined image frame after splicing, that is, it may have the same coordinates. In addition, the number of the plurality of image frames and the number of the plurality of combined image frames may be the same.

112, based on the plurality of combined image frames, generating the first target image frame, the exposure duration of each pixel in each of the combined image frames being the same.

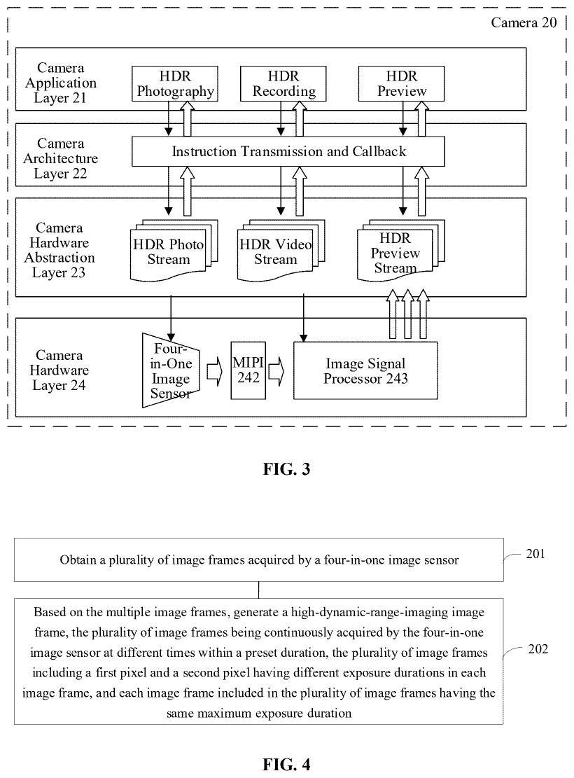

In some embodiments, when using a four-in-one image sensor to capture image frames, as shown in FIG. 2, for image frame 11, image frame 12 and image frame 13 captured in sequence by the four-in-one image sensor, each pixel unit (corresponding to 2*2 pixels) in each image frame may have the same color. Each image frame may include a pixel L with a long exposure duration, a pixel M with a medium exposure duration, and a pixel S with a short exposure duration. In each of the image frames included in the plurality of image frames, the exposure duration of pixels located at the same position may be different from each other. During implementation, pixels with the same exposure duration in each of the plurality of image frames may be spliced to obtain a combined image frame 14, a combined image frame 15, and a combined image frame 16. All pixels in the combined image frame 14 may be pixels L with a long exposure duration, all pixels in the combined image frame 15 may be pixels M with a medium exposure duration, and all pixels in the combined image frame 16 may be pixels S with a short exposure duration. Subsequently, the first target image frame 17 can be generated by combining the three image frames.

It should be understood that the image processing algorithm in the conventional technology generates an HDR image by using a plurality of images with different exposure durations, where the exposure duration of each pixel in each image is the same. Here, after splicing together plurality of combined image frames, since the exposure duration of each pixel in each combined image frame is the same, the image processing algorithm in the conventional technology can be reused to synthesize the plurality of combined image frames to obtain the first target image frame, which can improve the efficiency of synthesizing the first target image frame.

Consistent with the present disclosure, a plurality of combined image frames can be obtained by splicing pixels with the same exposure duration in each image frame included in the plurality of image frames, and the first target image frame can be generated based on the plurality of combined image frames. The exposure duration of each pixel in each combined image frame can be the same. In this way, by splicing pixels with the same exposure duration to generate a plurality of combined image frames, image information under different exposure conditions can be extracted and fused more accurately, thereby generating a high-quality first target image frame, effectively improving the image's detail and dynamic range.

In some embodiments, the process of generating the first target image frame based on a plurality of image frames may include the following process.

121, for each same position in each image frame included in the plurality of image frames, based on each pixel of each image frame located at the same position, generating a pixel located at the same position in the first target image frame.

In some embodiments, for pixels at the same position in the plurality of image frames, the HDR image may be synthesized by comparing the exposure values of the pixels at that position in each image frame at different exposure durations and selecting the pixels with the best exposure value. For example, for pixels in dark areas, pixels with larger exposure values in dark areas of the image frame can be selected as pixels in the HDR image to retain more details. For pixels at bright positions, pixels with smaller exposure values at bright positions in the image frame can be selected as pixels in the HDR image to avoid overexposure. It can be understood that as long as pixels at the same position in the plurality of image frames have different exposure duration, an HDR image can be synthesized.

In some embodiments, the pixels at the same position in the first target image frame may be generated in any suitable manner, which is not limited in the embodiments of the present disclosure. For example, pixels of the image frames at the same position may be fused by weighted averaging, maximum value fusion, minimum value fusion, etc. to obtain pixels at the same position in the first target image frame. It should be understood that the first target image frame generated in this way has the same number of pixels as the captured image frames, and the image quality of the generated first target image frame will not be reduced. In addition, the visual effect, detail retention, dynamic range, etc. of the first target image frame will be better than those of the captured image frames.

Consistent with the present disclosure, for each same position in each image frame included in the plurality of image frames, based on each pixel of each image frame located at the same position, a pixel located at the same position in the first target image frame can be generated. In this way, by integrating the information of pixels at the same position in the plurality of image frames, a first target image frame with richer details, wider dynamic range and less noise can be accurately generated, which can significantly improve the image quality.

In some embodiments, the image acquisition component may include a pixel array. The pixel array may include a plurality of pixel units, and a pixel unit may include a plurality of pixels. The process of obtaining a plurality of image frames acquired by the image acquisition component may include the following process.

131, for the plurality of image frame acquisitions performed by the image acquisition component, controlling different pixel units in the pixel array of the image acquisition component using the same exposure duration combination in a single image frame acquisition to obtain the plurality of image frames.

In some embodiments, the pixel array of the image acquisition component may be composed of a large number of pixel units, each of which is responsible for capturing a very small part of the information in the image, and these pixel units work together to generate a complete image frame. In addition, the exposure duration combination may refer to the exposure duration of each pixel in the pixel unit. For example, as shown in FIG. 2, every 2*2 pixels has the same exposure duration combination. The exposure duration combination in image frame 11 is a long-medium-medium-short (LMMS) exposure duration combination, while the exposure duration combination in image frame 12 is a short-long-long-medium (SLLM) exposure duration combination.

In some embodiments, the exposure control of the pixel unit may be performed using a filter covering the pixel unit.

Consistent with the present disclosure, by performing multiple image frame acquisitions on the image acquisition component, different pixel units in the pixel array of the image acquisition component can be controlled using the same exposure duration combination in a single image frame acquisition to obtain a plurality of image frames. In this way, by using a uniform exposure duration combination for the pixel units of the pixel array in a single image frame acquisition, a series of image frames with different exposure characteristics can be efficiently acquired, providing a rich data source for subsequent image processing and analysis, thereby helping to generate a more accurate and detailed first target image frame.

In some embodiments, the number of exposure durations in the image frame may be the same as the number of image frames in the plurality of image frames.

In some embodiments, when the plurality of image frames are two image frames, the number of exposure durations in each image frame may also be two. For example, if the plurality of image frames are two image frames, the exposure duration in each image frame may be a long exposure duration and a short exposure duration.

In some embodiments, when the plurality of image frame is three image frames, the number of exposure duration in each image frame may also be three. For example, if the plurality of image frames are three image frames, the exposure duration in each image frame may be a long exposure duration, a medium exposure duration, and a short exposure duration.

In some embodiments, when the plurality of image frame is four image frames, the number of exposure durations in each image frame may also be four. For example, if the plurality of image frames are four image frames, the exposure duration in each image frame may be a long exposure duration, a medium exposure duration, a second short exposure duration, and a short exposure duration.

In some embodiments, when using a four-in-one image sensor for image frame acquisition, since each pixel unit has 2*2 pixels, the pixel unit may have two to four different exposure durations.

In the embodiments of the present disclosure, since the number of exposure durations in the image frame is the same as the number of image frames in the plurality of image frames, and the exposure durations of pixels at the same position in each image frame included in the plurality of image frames are different from each other, the pixels at the same position in each of the image frames can be controlled with different exposure durations. This provides rich data support for subsequent image processing and analysis, and helps generate the first target image frame with richer details and wider dynamic range.

In some embodiments, the plurality of image frames may be a first image frame sequence comprising N image frames, N being an integer greater than 1. The process of generating the first target image frame based on the plurality of image frames may further include the following processes.

141, obtaining the next image frame acquired by the image acquisition component after the first image frame sequence, the pixels of the next image frame and the first image frame in the first image frame sequence located at the same position having the same exposure duration.

In some embodiments, when a four-in-one image sensor is used to capture image frames, the first image frame sequence may include three image frames. After the the first image frame and the second image frame in the first image frame sequence are obtained, the first image frame and the second image frame may be cached first, and after the third image frame in the first image frame sequence is obtained, the three image frames in the first image frame sequence may be used to synthesize the first target image frame. Different exposure duration combinations may be applied to the image frames in the first image frame sequence. For example, a long-medium-medium-short (LMMS) exposure duration combination may be applied to all pixel units of the first image frame in the first image frame sequence, a short-long-long-medium (SLLM) exposure duration combination may be applied all pixel units of the second image frame in the first image frame sequence, and a medium-short-short-long (MSSL) exposure duration combination may be applied to all pixel units of the third image frame in the first image frame sequence. Correspondingly, a long-medium-medium-short (LMMS) exposure duration combination may be applied to all pixel units of the next image frame. That is, the pixels at the same position in the next image frame and the first image frame in the first image frame sequence may have the same exposure duration.

142, based on a second image frame sequence, synthesizing a second target image frame, the second image frame sequence being an image frame sequence consisting of the 2^{nd} to N^{th} image frames in the first image frame sequence and the next image frame.

In some embodiments, the second target image frame may be an HDR image frame.

In some embodiments, when a four-in-one image sensor is used to capture image frames, if the a long-medium-medium-short (LMMS) exposure duration combination is applied to all pixel units of the first image frame of the first image frame sequence, a short-long-medium (SLLM) exposure duration combination is applied to all pixel units in the second image frame of the first image frame sequence, and a medium-short-short-long (MSSL) exposure duration combination is applied to all pixel units in the third image frame of the first image frame sequence, then, using the second image frame sequence, the second target image frame may be synthesized by a short-long-long-medium (SLLM) exposure duration combination to all pixel unit in the second image frame, a medium-short-short-long (MSSL) exposure duration combination to all pixel units in the third image frame, and a long-medium-medium-short (LMMS) exposure duration combination to all pixel units in the next image frame in sequence. It should be understood that, when shooting with a camera, the image acquisition component may continuously capture image frames. After the second target image frame is synthesized, a third image frame sequence, a fourth image frame sequence, etc. may also be determined in the form of a sliding window to subsequently synthesize a third target image frame, a fourth target image frame, etc. In this way, the camera can continuously output high-quality target image frames.

In some embodiments, when using a camera for shooting and HDR image output, as shown in FIG. 3, the user can choose to perform HDR photography, HDR recording or HDR preview in a camera application layer 21. When the user chooses to take HDR photos or record HDR, the camera application layer 21 may use a camera architecture layer 22 and a camera hardware abstraction layer 23 to transmit instructions and callbacks. The camera hardware abstraction layer 23 may be responsible for processing instructions from the camera architecture layer 22 and converting them into specific operations that can be executed by the camera hardware. At the camera hardware abstraction layer 23, HDR photo stream and HDR video stream may represent two different types of image data generated by the camera hardware. HDR photo stream may be a static, continuously shot photo stream, while HDR video stream may be a dynamic video stream composed of a plurality of photos. In a camera hardware layer 24, a four-in-one image sensor 241 may receive instructions from the camera hardware abstraction layer 23 and convert them into specific image processing tasks. The four-in-one image sensor 241 can capture a plurality of image frames and transmit the plurality of image frames to an image signal processor (ISP) 243 via a mobile industry processor interface (MIPI) 242. The image signal processor 243 performs four-in-one splitting, reorganization, HDR synthesis and tone processing on the plurality of image frames, and can generate and send an HDR preview stream to the camera hardware abstraction layer 23. The camera hardware abstraction layer 23 uses the camera architecture layer 22 and the camera application layer 21 to transmit and call back instructions. Finally, the camera application layer 21 can perform HDR preview based on the user's selection. In some embodiments, the four-in-one image sensor 241 can also be used to perform four-in-one splitting, reorganization, HDR synthesis, and tone processing, generate, and send an HDR preview stream to the camera hardware abstraction layer 23.

Consistent with the present disclosure, by obtaining the next image frame acquired by the image acquisition component after the first image frame sequence, the pixels at the same position in the next image frame and the first image frame in the first image frame sequence having the same exposure duration, a second target image frame can be synthesized based on the second image frame sequence, the second image frame sequence being an image frame sequence consisting of the 2^{nd} to the N^{th} image frames and the next image frame in the first image frame sequence. In this way, after the first target image frame synthesized, a second image frame sequence can be obtained by multiplexing some image frames in the first image frame sequence and capturing a new next image frame. Then the second image frame sequence can be used to synthesize the second target image frame, thereby achieving efficient and coherent image synthesis, improving image processing efficiency, and being able to generate high-quality images with low latency.

In some embodiments, the process of generating the first target image frame based on the plurality of image frames may further include the following processes.

151, based on a pixel deviation value between the plurality of image frames, determining a displacement distance between the plurality of image frames.

In some embodiments, the pixel deviation value between the image frames may be determined by comparing the corresponding pixels between adjacent image frames. The pixel deviation value can reflect the displacement distance, rotation or scale change between the image frames.

152, aligning the plurality of image frames based on the displacement distance to obtain a plurality of aligned image frames.

In some embodiments, a reference frame may be determined from the plurality of image frames, and the remaining image frames may be used as non-reference frames. The non-reference frames may be moved based on the calculated displacement distance to align the non-reference frames with the reference frames, thereby obtaining the plurality of aligned image frames. It should be understood that this process generally involves performing an affine transformation (including translation, rotation, scaling, etc.) on the image frames such that the same feature points in different image frames can coincide.

153, synthesizing the first target image frame based on the plurality of aligned image frames.

In some embodiments, HDR synthesis may be performed using the plurality of aligned image frames to obtain a high-quality first target image frame.

Consistent with the present disclosure, by determining the displacement distance between the plurality of image frames based on the pixel deviation value between the plurality of image frames, and aligning the plurality of image frames based on the displacement distance to obtain a plurality of aligned image frames, the first target image frame can be synthesized based on the plurality of aligned image frames. In this way, the alignment process is beneficial to obtaining a first target image frame with higher quality in subsequent synthesis.

The following describes the application of the image processing method provided in the embodiment of the present application in a practical scenario. The use of an image sensor for image acquisition is taken as an example.

At present, when shooting with electronic devices, there are a variety of technical solutions for performing HDR image synthesis after the image frames are acquired using image sensors.

In the first technical solution, when synthesizing an HDR image from a plurality of image frames, the same exposure duration needs to be applied to all pixels on the entire image sensor. Since the image sensor sequentially applies significantly different exposure durations, the image sensor needs to converge to effectively output image frames, which greatly limits the efficiency of outputting HDR images. This HDR image synthesis method is only suitable for taking photos, not for recording videos.

In the second technical solution, after a single image frame is acquired using a four-in-one image sensor, the single image frame is split into multiple split frames, and then the multiple split frames are used to synthesize a single HDR image. Since the resolution of the split frames is lower than that of the image frames acquired by the four-in-one image sensor, and the resolution of the synthesized HDR image is consistent with the split frames, the resolution of the synthesized HDR image is not high and the resolution loss is large.

Based on this, an embodiment of the present disclosure provides an image processing method. FIG. 4 is a flowchart of the image processing method according to some embodiments of the present disclosure. The method will be described in detail below.

201, obtaining a plurality of image frames acquired by a four-in-one image sensor.

202, based on the multiple image frames, generating a high-dynamic-range-imaging image frame.

In some embodiments, the plurality of image frames may be continuously acquired by the four-in-one image sensor at different times within a preset duration. The plurality of image frames may include a first pixel and a second pixel having different exposure durations in each image frame, and each image frame included in the plurality of image frames may have the same maximum exposure duration.

Consistent with the present disclosure, by obtaining a plurality of image frames acquired by a four-in-one image sensor, a high-dynamic-range-imaging image frame can be generated based on the plurality of image frames. The plurality of image frames may be continuously acquired by the four-in-one image sensor at different times within a preset duration. The plurality of image frames may include a first pixel and a second pixel having different exposure durations in each image frame, and each image frame included in the plurality of image frames may have the same maximum exposure duration. In this way, since each image frame has the same maximum exposure duration, when the four-in-one image sensor is used to acquire multiple image frames, the same exposure duration can be sequentially applied to the entire four-in-one image sensor. Then, multiple image frames can be obtained by performing differential exposure control on pixels such that the four-in-one image sensor can effectively output image frames without convergence. This improves the efficiency of generating high-dynamic-range-imaging image frames using multiple image frames, thereby effectively improving the user experience.

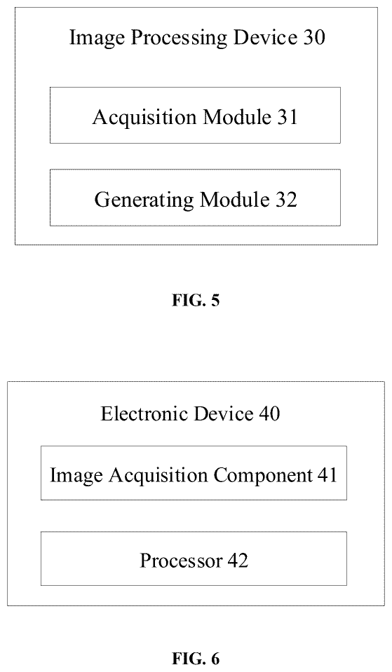

Embodiments of the present disclosure provide an image processing device. FIG. 5 is a schematic structural diagram of an image process device 30 according to some embodiments of the present disclosure. As shown in FIG. 5, the image process device 30 includes an acquisition module 31 and a generating module 32.

In some embodiments, the acquisition module 31 may be configured to obtain a plurality of image frames acquired by the image acquisition component.

In some embodiments, the generating module 32 may be configured to generate a first target image frame based on the plurality of image frames. The plurality of image frames may be obtained by the image acquisition component continuously acquiring at different times within a preset time period. The plurality of image frames may include a first pixel and a second pixel, each of which having a different exposure duration. The plurality of image frames may include image frames with the same maximum exposure duration.

In some embodiments, in each of the image frames included in the plurality of image frames, the exposure durations of pixels located at the same position may be different from each other.

In some embodiments, the generating module 32 may also be configured to splice the pixels with the same exposure duration in each of the plurality of image frames to obtain a plurality of combined image frames, and based on the plurality of combined image frames, generate the first target image frame, the exposure duration of each pixel in each of the combined image frames being the same.

In some embodiments, the generating module 32 may also be configured to, for each same position in each image frame included in the plurality of image frames, based on each pixel of each image frame located at the same position, generate a pixel located at the same position in the first target image frame.

In some embodiments, the image acquisition component may include a pixel array. The pixel array may include a plurality of pixel units, and a pixel unit may include a plurality of pixels. The acquisition module 31 may be further configured to, for the plurality of image frame acquisitions performed by the image acquisition component, control different pixel units in the pixel array of the image acquisition component using the same exposure duration combination in a single image frame acquisition to obtain the plurality of image frames.

In some embodiments, the number of exposure durations in the image frame may be the same as the number of image frames in the plurality of image frames.

In some embodiments, the plurality of image frames may be a first image frame sequence comprising N image frames, N being an integer greater than 1. The image processing device may further include a synthesis module 33. The synthesis module 33 may be configured to obtain the next image frame acquired by the image acquisition component after the first image frame sequence, the pixels of the next image frame and the first image frame in the first image frame sequence located at the same position having the same exposure duration, and based on a second image frame sequence, synthesize a second target image frame, the second image frame sequence being an image frame sequence consisting of the 2^{nd} to N^{th} image frames in the first image frame sequence and the next image frame.

In some embodiments, the generating module 32 may be further configured to, based on a pixel deviation value between the plurality of image frames, determine a displacement distance between the plurality of image frames; align the plurality of image frames based on the displacement distance to obtain a plurality of aligned image frames; synthesize the first target image frame based on the plurality of aligned image frames.

The description of the above device embodiment is similar to the description of the above method embodiment and has similar beneficial effects as the method embodiment. The functions or modules included in the device provided in the embodiments of the present disclosure can be used to execute the method described in the above method embodiments. For technical details not disclosed in the embodiments of the device of the present disclosure, refer can be made to the description of the method embodiments of the present disclosure.

In some embodiments, the image processing method may be implemented as a software function module which may be sold or used as an independent product. Therefore, it may be stored in a computer readable storage medium. All or part of the steps to implement the above method embodiments may be implemented as a software product, and the software product may be stored in a storage medium and may include instructions for controlling an electronic device (such as a personal computer or a server, etc.) to execute all or part of the above methods. The aforementioned storage media may include: flash disks, removable storage devices, ROMs, magnetic disks, optical disks or other media that can store program codes. Thus, the embodiments of the present disclosure are not limited to any specific hardware, software or firmware, or any combination of hardware, software and firmware.

Embodiments of the present disclosure provide an electronic device. FIG. 6 is a schematic structural diagram of an electronic device 40 according to some embodiments of the present disclosure. As shown in FIG. 6, the electronic device 40 includes an image acquisition component 41 and a processor 42.

In some embodiments, the processor 42 may be configured to obtain a plurality of image frames acquired by the image acquisition component 41; generate a first target image frame based on the plurality of image frames. The plurality of image frames may be obtained by the image acquisition component 41 continuously acquiring at different times within a preset time period. The plurality of image frames may include a first pixel and a second pixel, each of which having a different exposure duration. The plurality of image frames may include image frames with the same maximum exposure duration.

In some embodiments, the image acquisition component 41 may be configured to acquire a plurality of image frames.

Embodiments of the present disclosure provide an electronic device including a memory and a processor. The memory stores a computer program that can be run on the processor, and when the processor executes the program, some or all of the steps in the above method can be implemented.

Embodiments of the present disclosure provide a computer-readable storage medium having a computer program stored thereon, which, when executed by a processor, implements some or all of the steps in the above method or the computer program is executed in the processor provided in the above embodiment. The computer readable storage medium may be transitory or non-transitory.

Embodiments of the present disclosure provide a computer program including computer readable code. When the computer readable code is executed in a computer device, a processor in the computer device executes a part or all of the steps in the above method or the processor is the processor provided in the above embodiment.

Embodiments of the present disclosure provide a computer program product, including a non-transient computer-readable storage medium storing the computer program that, when read and executed by a computer, causes the computer to perform some or all of the steps of the method above. The computer program product can be implemented by hardware, software, or a combination thereof. In some embodiments, the computer program product can be embodied as a computer storage medium. In some other embodiments, the computer program product can be embodied as a software product, such as a Software Development Kit (SDK).

The above description of the various embodiments tends to emphasize the differences between the various embodiments, and the same or similarities may be referred to each other. The description of the above device, storage medium, computer program and computer program product embodiments is similar to the description of the above method embodiments and has similar beneficial effects as the method embodiments. For technical details not disclosed in the embodiments of the device, storage medium, computer program, and computer program product of this application, reference can be made to the description of the embodiment of the method of the present disclosure.

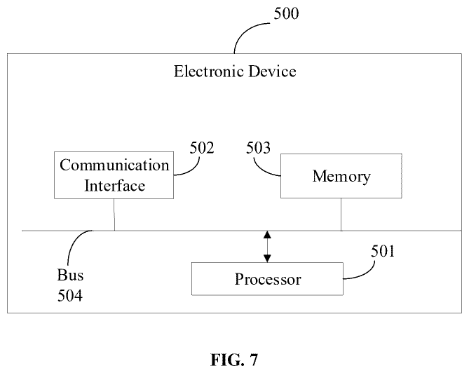

Embodiments of the present disclosure also provide an electronic device. FIG. 7 is a schematic structural diagram of an electronic device according to some embodiments of the present disclosure. As shown in FIG. 7, the electronic device 700 includes a processor 501, a communication interface 502, and a memory 503.

In some embodiments, the processor 501 may be configured to generally control the overall operation of electronic device 700.

In some embodiments, the communication interface 502 may be configured to enable the electronic device to communicate with other terminals or servers through a network.

In some embodiments, the memory 503 may be configured to store instructions and applications executable by the processor 501, and may also cache data to be processed or processed by the processor 501 and each module in the electronic device 500 (for example, image data, audio data, voice communication data, or video communication data). The memory may be implemented through flash memory (FLASH) or random-access memory (RAM). Data transmission may be carried out between the processor 501, the communication interface 502 and the memory 503 through a bus 504. When the processor 501 executes the program, some or all of the steps in the above method can be implemented, or the processor 501 can be the processor provided in the above embodiment, and the memory 503 can include the cache module provided in the above embodiment.

In the present disclosure, description with reference to the terms “one embodiment,” “some embodiments,” “example,” “specific example,” or “some examples,” etc., means that specific features described in connection with the embodiment or example, structure, material or feature is included in at least one embodiment or example of the present disclosure. Furthermore, the particular features, structures, materials or characteristics described may be combined in any suitable manner in any one or more embodiments or examples. Furthermore, those skilled in the art may combine the different embodiments or examples described in this specification, as well as the features of the different embodiments or examples, without conflicting each other. In various embodiments of the present disclosure, the size of the sequence numbers of the above-mentioned processes does not mean the sequence of execution, and the execution sequence of each process should be determined by its functions and internal logic, rather than the implementation process of the embodiments of the present disclosure. The above-mentioned serial numbers of the embodiments of the present application are only for description, and do not represent the advantages or disadvantages of the embodiments. The above description of the various embodiments tends to emphasize the differences between the various embodiments, and the same or similar points can be referred to each other, and for the sake of brevity, details are not repeated herein.

In the present disclosure, the terms “comprising,” “including” or any other variation thereof are intended to encompass a non-exclusive inclusion such that a process, method, article or device comprising a list of elements includes not only those elements, but also others not expressly listed elements, or also include elements inherent to such a process, method, article or apparatus. Without further limitation, an element qualified by the phrase “comprising a . . . ” does not preclude the presence of additional identical elements in a process, method, article or apparatus that includes the element.

In the embodiments provided in the present disclosure, it should be understood that the disclosed system, device, and method may be implemented in other ways. For example, the apparatus embodiments described above are only illustrative. For example, the division of the units is only a logical function division, and there may be other divisions in actual implementation. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments of the present disclosure.

In addition, the functional units in the various embodiments of the present disclosure may be integrated into one processing unit, or each unit may exist alone physically, or two or more units may be integrated into one unit. The above-mentioned integrated unit can be implemented in the form of hardware or software functional unit.

A person of ordinary skill in the art can be aware that all or part of the processes in the method embodiments of the present disclosure can be implemented by hardware related to the program instructions. The program may be stored in a computer-readable storage medium. When the program executes, the processes of the method embodiments may be executed. The aforementioned storage medium includes: a mobile storage medium, a read-only memory (ROM), a magnetic disk, an optical disk, or another medium that can store program codes.

When the integrated unit is implemented in the form of a software functional unit and sold or used as an independent product, it can be stored in a computer-readable storage medium. Based on this understanding, all or part of the technical solution can be embodied in the form of a software product. The computer software product is stored in a storage medium, and includes several instructions to enable a computer device (which may be a personal computer, a server, or a network device, etc.) to perform all or part of the steps of the method described in each embodiment of the present disclosure. The aforementioned storage medium includes: a mobile storage medium, a read-only memory (ROM), a magnetic disk, an optical disk, or another medium that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

What is claimed is:

1. An image processing method comprising:
obtaining a plurality of image frames acquired by an image acquisition component; and
based on the plurality of image frames, generating a first target image frame, wherein the plurality of image frames are obtained by the image acquisition component continuously acquiring at different times within a preset time period, the plurality of image frames include a first pixel and a second pixel, each of which having a different exposure duration, the plurality of image frames include image frames with the same maximum exposure duration.

2. The image processing method of claim 1, wherein
in each of the image frames included in the plurality of image frames, exposure durations of pixels located at the same position are different from each other.

3. The image processing method of claim 2, wherein generating the first target image frame based on the plurality of image frames include:
splicing the pixels with the same exposure duration in each of the plurality of image frames to obtain a plurality of combined image frames; and
based on the plurality of combined image frames, generating the first target image frame, the exposure duration of each pixel in each of the combined image frames being the same.

4. The image processing method of claim 2, wherein generating the first target image frame based on the plurality of image frames include:
for each same position in each image frame included in the plurality of image frames, based on each pixel of each image frame located at the same position, generating a pixel located at the same position in the first target image frame.

5. The image processing method of claim 2, wherein:
the image acquisition component includes a pixel array, the pixel array includes a plurality of pixel units, and a pixel unit includes a plurality of pixels; and
obtaining the plurality of image frames acquired by the image acquisition component includes:
for the plurality of image frame acquisitions acquired by the image acquisition component, controlling different pixel units in the pixel array of the image acquisition component using the same exposure duration combination in a single image frame acquisition to obtain the plurality of image frames.

6. The image processing method of claim 2, wherein:
the number of exposure durations in the image frame is the same as the number of image frames in the plurality of image frames.

7. The image processing method of claim 1, wherein:
the plurality of image frames is a first image frame sequence including N image frame, N being an integer greater than 1;
after generating the first target image frame based on the plurality of image frames, the method further comprising:
obtaining a next image frame acquired by the image acquisition component after the first image frame sequence, the pixels of the next image frame and the first image frame in the first image frame sequence located at the same position having the same exposure duration; and
based on a second image frame sequence, synthesizing a second target image frame, the second image frame sequence being an image frame sequence consisting of the 2^{nd} to N^{th} image frames in the first image frame sequence and the next image frame.

8. The image processing method of claim 1, wherein generating the first target image frame based on the plurality of image frames includes:
based on a pixel deviation value between the plurality of image frames, determining a displacement distance between the plurality of image frames;
aligning the plurality of image frames based on the displacement distance to obtain a plurality of aligned image frames; and
synthesizing the first target image frame based on the plurality of aligned image frames.

9. An electronic device comprising:
an image acquisition component, the image acquisition component being configured to acquire a plurality of image frames; and
a processor, the processor being configured to obtain the plurality of image frames acquired by the image acquisition component, and generate a first target image frame based on the plurality of image frames, wherein:
the plurality of image frames are obtained by the image acquisition component continuously acquiring at different times within a preset time period, the plurality of image frames include a first pixel and a second pixel, each of which having a different exposure duration, the plurality of image frames include image frames with the same maximum exposure duration.

10. The electronic device of claim 9, wherein
in each of the image frames included in the plurality of image frames, exposure durations of pixels located at the same position are different from each other.

11. The electronic device of claim 10, wherein the processor is further configured to:
splice the pixels with the same exposure duration in each of the plurality of image frames to obtain a plurality of combined image frames; and
based on the plurality of combined image frames, generate the first target image frame, the exposure duration of each pixel in each of the combined image frames being the same.

12. The electronic device of claim 10, wherein the processor is further configured to:
for each same position in each image frame included in the plurality of image frames, based on each pixel of each image frame located at the same position, generate a pixel located at the same position in the first target image frame.

13. The electronic device of claim 10, wherein:
the image acquisition component includes a pixel array, the pixel array includes a plurality of pixel units, and a pixel unit includes a plurality of pixels; and
the image acquisition component is further configured to:
for the plurality of image frame acquisitions acquired by the image acquisition component, control different pixel units in the pixel array of the image acquisition component using the same exposure duration combination in a single image frame acquisition to obtain the plurality of image frames.

14. The electronic device of claim 10, wherein:
the number of exposure durations in the image frame is the same as the number of image frames in the plurality of image frames.

15. The electronic device of claim 9, wherein:
the plurality of image frames is a first image frame sequence including N image frame, N being an integer greater than 1;
the processor is further configured to:
obtain a next image frame acquired by the image acquisition component after the first image frame sequence, the pixels of the next image frame and the first image frame in the first image frame sequence located at the same position having the same exposure duration; and
based on a second image frame sequence, synthesize a second target image frame, the second image frame sequence being an image frame sequence consisting of the 2^{nd} to N^{th} image frames in the first image frame sequence and the next image frame.

16. The electronic device of claim 9, wherein the processor is further configured to:
based on a pixel deviation value between the plurality of image frames, determine a displacement distance between the plurality of image frames;
align the plurality of image frames based on the displacement distance to obtain a plurality of aligned image frames; and
synthesize the first target image frame based on the plurality of aligned image frames.

17. An image processing device comprising:
an image acquisition module, the image acquisition module being configured to obtain a plurality of image frames acquired by an image acquisition component; and
a generating module, the generating module being configured to generate a first target image frame based on the plurality of image frames, wherein:
the plurality of image frames are obtained by the image acquisition component continuously acquiring at different times within a preset time period, the plurality of image frames include a first pixel and a second pixel, each of which having a different exposure duration, the plurality of image frames include image frames with the same maximum exposure duration.

18. The image processing device of claim 17, wherein
in each of the image frames included in the plurality of image frames, exposure durations of pixels located at the same position are different from each other.

19. The image processing device of claim 18, wherein the generating module is further configured to:
splice the pixels with the same exposure duration in each of the plurality of image frames to obtain a plurality of combined image frames; and
based on the plurality of combined image frames, generate the first target image frame, the exposure duration of each pixel in each of the combined image frames being the same.

20. The image processing device of claim 18, wherein the generating module is further configured to:
for each same position in each image frame included in the plurality of image frames, based on each pixel of each image frame located at the same position, generate a pixel located at the same position in the first target image frame.
